(19) United States
(12) Patent Application Publication
(10) Pub. No.: US 2024/0265300 A1
(43) Pub. Date: Aug. 8, 2024

(54) MODEL OPTIMIZATION DEVICE, METHOD, AND RECORDING MEDIUM FOR PARAMETER ESTIMATION CONCERNING OPTICAL COMMUNICATIONS

(71) Applicant: NEC Corporation, Minato-ku, Tokyo (JP)

(72) Inventors: Yuji KOBAYASHI, Tokyo (JP); Yoshiaki SAKAE, Tokyo (JP); Takashi KONASHI, Tokyo (JP); Hiroki TAGATO, Tokyo (JP); Jun NISHIOKA, Tokyo (JP); Jun KODAMA, Tokyo (JP); Etsuko ICHIHARA, Tokyo (JP)

(73) Assignee: NEC Corporation, Minato-ku, Tokyo (JP)

(21) Appl. No.: 18/290,190

(22) PCT Filed: May 18, 2021
(86) PCT No.: PCT/JP2021/018731

§ 371 Date: Nov. 10, 2023

(51) Int. Cl. G06N 20/00

(52) U.S. Cl. CPC G06N 20/00

(57) ABSTRACT

In a model optimization device for a parameter estimation concerning optical communications, A model acquisition acquires a trained model. A data acquisition means acquires data from a terminal device. A model update means performs a model update of the trained model step by step to generate an updated model based on the data. A model output means outputs to an output destination device corresponding to the terminal device.

### TECHNICAL FIELD

the present disclosure relates to an optimization of a model for a parameter estimation concerning optical communications.

### BACKGROUND ART

Data measured using sensors or the like in terminal devices installed in various environments may be analyzed using an analysis model prepared in advance. In this case, the analysis model used in each of terminal devices is desired to be appropriate for each of the terminal devices.

Patent Document 1 discloses a system which includes a device having a learning device for performing a process using a learned model, and a server device. In this system, the server device stores a plurality of shared models which have been trained in advance, and selects an appropriate shared model for the device based on the data acquired from the device, and sends the selected model to the device. Also, the device is able to perform additional training on the shared model received from the server device.

### PRECEDING TECHNICAL REFERENCES

### Patent Document

Patent Document 1: International Publication Pamphlet No. WO2018/173121

### SUMMARY

### Problem to be Solved by the Invention

In the system described in Patent Document 1, in a case where there is a large divergence between a data distribution used to create a shared model and a data distribution of a device to which the shared model is applied, it may not be possible to obtain a sufficient benefit from additional training.

It is one object of the present disclosure to optimize a model to be used in each of terminal devices according to unique characteristics and environmental characteristics concerning individual terminal devices.

### Means for Solving the Problem

According to an example aspect of the present disclosure, there is provided a model optimization device for a parameter estimation concerning optical communications, the model optimization device including:
a model acquisition means configured to acquire a trained model;
a data acquisition means configured to acquire data from a terminal device;
a model update means configured to generate an updated model by performing a model update of the trained model step by step based on the data; and
a model output means configured to output the updated model to an output destination device corresponding to the terminal device.

According to another example aspect of the present disclosure, there is provided model optimization method for a parameter estimation concerning optical communications, the model optimization method including:
acquiring a trained model;
acquiring data from a terminal device;
generating an updated model by performing a model update of the trained model step by step based on the data; and
outputting the updated model to an output destination device corresponding to the terminal device.

According to a further example aspect of the present disclosure, there is provided a recording medium storing a model optimization program for a parameter estimation concerning optical communications, the model optimization program causing a computer to perform a process including:
acquiring a trained model;
acquiring data from a terminal device;
generating an updated model by performing a model update of the trained model step by step based on the data; and
outputting the updated model to an output destination device corresponding to the terminal device.

### Effect of the Invention

According to the present disclosure, it is possible to more appropriately generate and optimize a model to be used in each of terminal devices according to unique characteristics and environmental characteristics for individual terminal devices.

### BRIEF DESCRIPTION OF THE DRAWINGS

FIG. 1 illustrates an overall configuration of an optical network system according to a first example embodiment.

FIG. 2A and FIG. 2B are block diagrams illustrating hardware configurations of a server and an analyzer.

FIG. 3 is a block diagram illustrating functional configurations of the server and the analyzer.

FIG. 4 illustrates an example of training data used to generate an analysis model.

FIG. 5 schematically illustrates an example of optimization phases of the analysis model.

FIG. 6A and FIG. 6B are diagrams for explaining an example of an optimization of the analysis model.

FIG. 7 is a diagram for explaining an example of the optimization of the analysis model.

FIG. 8 is a diagram for explaining a creation method of the generic model.

FIG. 9 illustrates examples of an optimization of a model in various cases.

FIG. 10 illustrates examples of the optimization of the model in various cases.

FIG. 11 is a flowchart of a model optimization process.

FIG. 12 is a block diagram illustrating a functional configuration of a model optimization device of a second example embodiment.

FIG. 13 is a flowchart of a process by the model optimization device of the second example embodiment.

### EXAMPLE EMBODIMENTS

In the following, example embodiments will be described with reference to the accompanying drawings.

### First Example Embodiment

### [Overall Configuration]

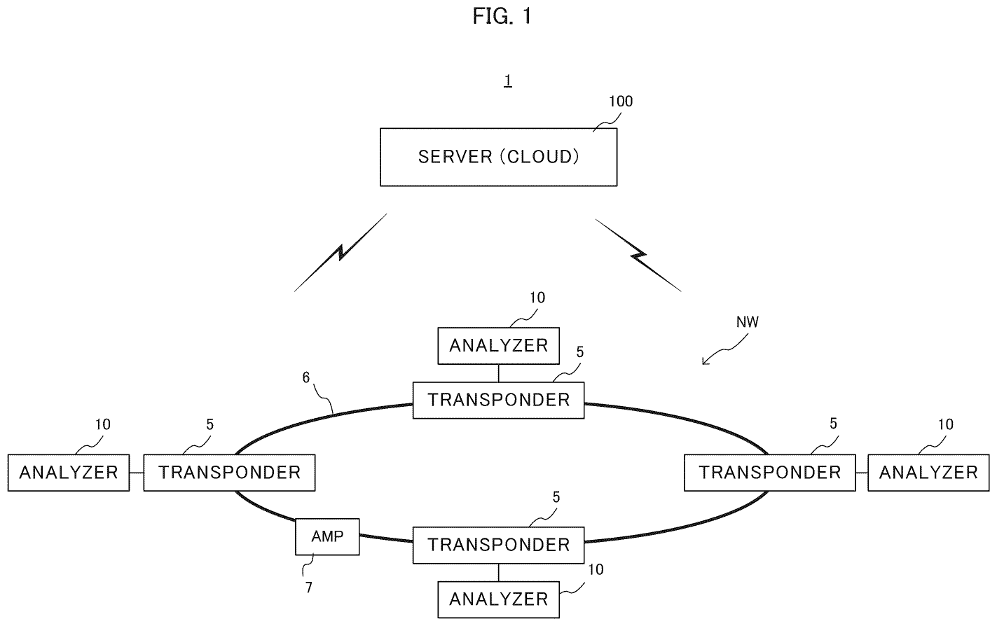

FIG. 1 illustrates an overall configuration of an optical network system (hereinafter, simply referred to as a “system”) 1 according to a first example embodiment. The system 1 includes a server (cloud device) 100 and an optical network NW. The optical network NW includes a plurality of transponders 5 connected by an optical cable 6, and analyzers 10 provided correspondingly to the transponders 5. Note that, each of the optical cable 6 for connecting the transponders 5 is supplied with an amplifier 7 as needed.

Each of the transponders 5 corresponds to an example of a terminal device, and the transponders 5 are installed in corresponding predetermined places. Each of the transponders 5 includes a sensor, a measurement section, and the like, acquires data concerning the communication state during executions of communications on the optical network NW, and outputs the data to the corresponding analyzer 10. Typically, the data are time series data measured by the sensor, the measurement section, or the like.

Each analyzer 10 uses the data input from the corresponding transponder 5 to analyze the communication state or the like concerning the transponder 5. The analyzer 10 analyzes the data using an analysis model prepared in advance. Specifically, the analyzer 10 estimates communication quality parameters of the optical network NW based on the data measured by the sensor or the like provided in the transponder 5. For instance, the analyzer 10 calculates a SN ratio (OSNR: Optical Signal-to-Noise Ratio) in communication.

A server 100 communicates with each of the transponders 5 and each of the analyzers 10 by wired or wireless communications. Specifically, each transponder sends the data measured by the sensor or the like to the server 100. The server 100 generates the analysis model based on the data received from the transponder 5, and outputs the analysis model to the analyzer 10. As will be described in more detail below, the server 100 provides, to the analyzer 10, the analysis model which is optimized to adapt to unique characteristics of the transponder 5 and the environmental characteristics of a location where the transponder 5 is installed.

### [Hardware Configuration]

### (Server)

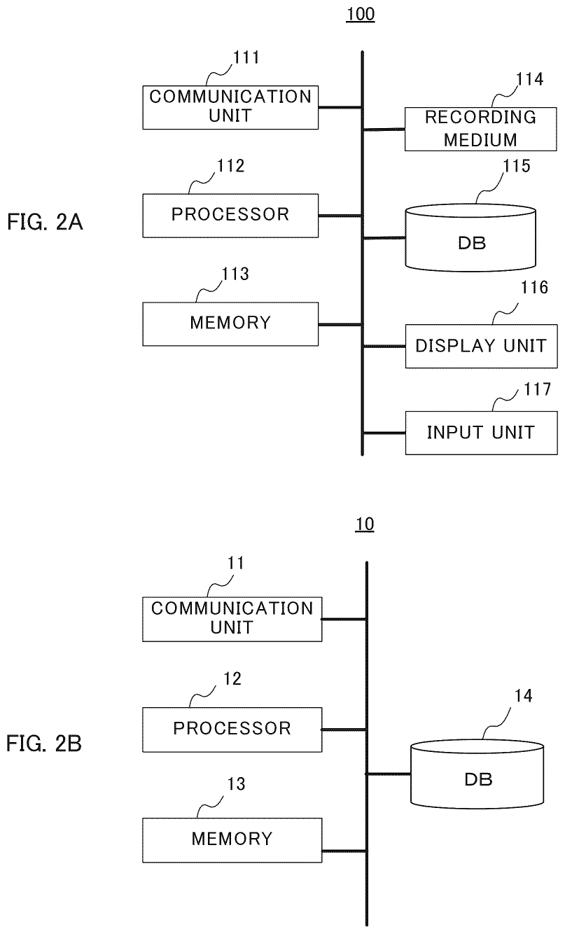

FIG. 2A is a block diagram illustrating a hardware configuration of the server 100. The server 100 includes a communication unit 111, a processor 112, a memory 113, a recording medium 114, a database (DB) 115, a display unit 116, and an input unit 117.

The communication unit 111 sends and receives data to and from the transponders 5 and the analyzers 10. Specifically, the communication unit 111 receives data from the transponders 5 and sends respective analysis models to the analyzers 10.

The processor 112 is a computer such as a CPU (Central Processing Unit, and controls the entire server 100 by executing programs prepared in advance. The processor 112 may be a GPU (Graphics Processing Unit), a FPGA (Field-Programmable Gate Array), or the like. The processor 112 performs a model optimization process described later.

The memory 113 forms a ROM (Read Only Memory, a RAM (Random Access Memory), and the like. The memory 113 is also used as a working memory during executions of various process by the processor 112.

The recording medium 114 is a non-volatile and non-transitory recording medium such as a disk-shaped recording medium or a semiconductor memory, and is formed to be detachable from the server 100. The recording medium 114 records various programs executed by the processor 112. In a case where the server 100 executes various processes, the programs recorded in the recording medium 114 is loaded into the memory 113 and executed by the processor 112. The DB 115 stores data transmitted from the transponders 5, the respective analysis models output to the analyzers 10, and the like.

The display unit 116 is, for instance, a liquid crystal display device, and displays necessary information to an operator. The input unit 117 is an input device such as a mouse, a keyboard, or a touch panel, and is operated by the operator at a time of necessary instructions or input.

### (Analyzers)

FIG. 2B is a block diagram illustrating a hardware configuration of each of the analyzers 10. Each of the analyzers 10 includes a communication unit 11, a processor 12, a memory 13, and a database (DB) 14.

The communication unit 11 sends and receives data to and from the server 100. Specifically, the communication unit 11 receives the analysis model from the server 100.

The processor 12 is a computer such as a CPU, and controls the entire analyzer 10 by executing programs prepared in advance. Note that the processor 12 may be a GPU, a FPGA or the like. The processor 12 analyzes data input from transponder 5 using the analysis model received from the server 100.

The memory 13 is formed by a ROM, a RAM or the like. The memory 13 is also used as a working memory during executions of processes by the processor 12. The DB 14 stores the data obtained from the corresponding transponder 5, the analysis model received from the server 100, and the like.

### [Functional Configurations]

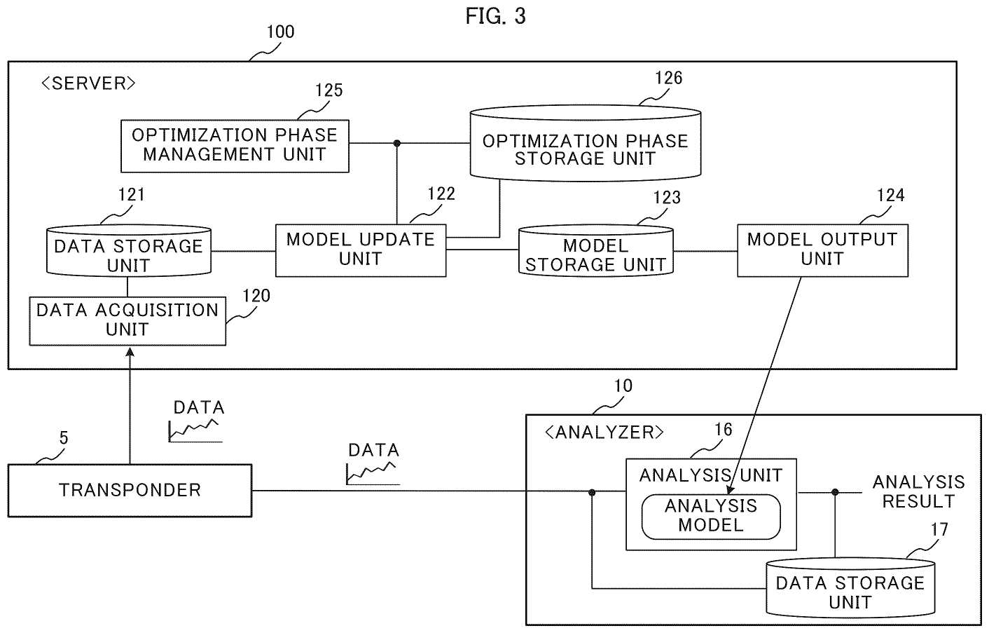

FIG. 3 is a block diagram illustrating functional configurations of the server 100 and the analyzer 10. The server 100 includes a data acquisition unit 120, a data storage unit 121, a model update unit 122, a model storage unit 123, a model output unit 124, an optimization phase management unit 125, and an optimization phase storage unit 126.

The data acquisition unit 120 acquires data sent from the external terminal device such as the transponder 5 and the like. The data storage unit 121 temporarily stores the data acquired by the data acquisition unit 120.

The model update unit 122 generates and updates each analysis model to be output to the analyzer 10 using the data stored in the data storage unit 121. The updating of the analysis model by the model update unit 122 is performed in order to generate and optimize the analysis model more appropriately according to each analyzer 10. In a case where a new transponder 5 is installed, the model update unit 122 generates a new analysis model to be used in the analyzer 10 corresponding to the new transponder 5. Moreover, the model update unit 122 updates the analysis model used in the analyzer 10 which has existed, at a predetermined timing. The model update unit 122 outputs the new analysis model which has been created and the model which has been updated (hereinafter, also referred to as an “updated model”), to the model storage unit 123.

In a case where the update of the model, the model update unit 122 performs additional training using the existing model and new data. The additional training here may be a re-training for further learning the existing model using the new data, or a transfer learning for adapting a model of an existing domain to a new domain.

The model storage unit 123 stores the analysis model output to the analyzer in association with the transponder 5 and the analyzer 10. The model storage unit 123 may store a plurality of analysis models previously used by the analyzer 10, that is, from previous analysis models to latest analysis models, in association with the transponder 5 and the analyzer 10.

The model output unit 124 outputs the analysis model stored in the model storage unit 123 to each analyzer 10. Basically, the model output unit 124 outputs the latest updated analytical model for each analyzer 10 to the analyzer 10. That is, when a new transponder 5 is set, the model output unit 124 outputs a newly created analytical model to the analyzer 10 corresponding to that new transponder 5. In addition, when the analysis model of the analyzer 10 needs to be updated, and the model update unit 122 generates an updated model and stores the updated model in the model storage unit 123, the model output unit 124 outputs the updated model to the analyzer 10.

The optimization phase management unit 125 manages phases of an optimization for models by the model update unit 122. Although the details will be described later, the optimization of each analysis model by the model update unit 122 is performed step by step through a plurality of optimization phases. The optimization phase management unit 125 recognizes at which of the plurality of optimization phases the update of the model by the model update unit 122 is in, and records that phase in the optimization phase storage unit 126.

The optimization phase storage unit 126 stores information indicating which optimization phase the update of the model by the model update unit 122 is currently in. The model update unit 122 advances the update of the model by referring to the optimization phase recorded in the optimization phase storage unit 126.

On the other hand, the analyzer 10 includes an analysis unit 16, and a data storage unit 17. The analysis unit 16 analyzes data input from the transponder 5 using the analysis model, and outputs an analysis result. The analysis model is an analysis model output from the model output unit 124 of the server 100, and is basically the latest updated model for the analyzer 10.

The data storage unit 17 stores the data input from the transponder 5. The data storage unit 17 stores the analysis result by the analysis unit 16.

In the above-described configuration, the model update unit 122 corresponds to an example of a model acquisition means and a model update means, the data storage unit 121 corresponds to an example of the data acquisition means, and the model output unit 124 corresponds to an example of the model output means.

### [Analysis Model]

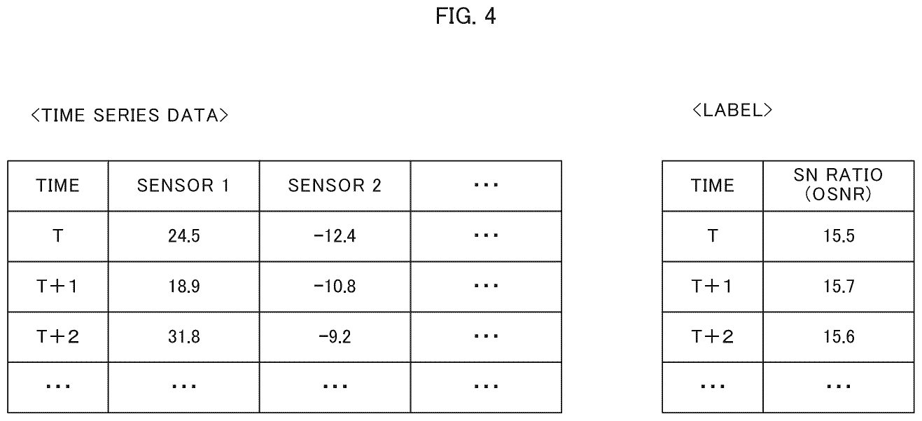

The analysis model used by the analyzer 10 will now be described. FIG. 4 illustrates an example of training data used to generate the analysis model. The analysis model is a model which estimates predetermined parameters indicating an operation state of the transponder 5, a state of a transmission path, and the like based on the time series data acquired by the transponder 5. In the example illustrated in FIG. 4, the time series data output from the plurality of sensors provided in the plurality of transponders 5 are used as input data for training, and the SN ratio (OSNR) value is prepared as a label (correct answer label) for each input data.

The model update unit 122 trains the analysis model using the training data with the time series data illustrated in FIG. 4 as input data and the labels as correct labels. As the analysis model, for instance, a deep learning model (DNN: Deep Neural Network) or the like can be used. The type of the analysis model is not limited to the deep learning model, and any of various machine learning models which perform prediction, classification, and the like according to a content of an analysis to be performed in the analyzer 10 can be used.

In the example in FIG. 4. DNN weight parameters are optimized by training, and the analysis model is generated. Upon inputting the time series data obtained from the transponder 5, that is, values which are measured by the plurality of sensors (a sensor 1, a sensor 2, . . . ) at each time, this analysis model estimates the OSNR at that time. Note that the analysis is not limited to the OSNR, and an analysis model for outputting values of various parameters related to the state of the transponder 5 or the like can be used.

### [Optimization of Model]

### (Optimization Method)

Next, the optimization of the analysis model by the model update unit 122 will be described in detail. In this example embodiment, the model optimization is performed step by step through the plurality of optimization phases. Due to a nature of the optical network NW, factors affecting the data distribution measured by each transponder 5 can be broadly classified into the unique characteristics of the transponder 5 and the environmental characteristics of a location where the transponder 5 is installed.

Here, the unique characteristics refer to the characteristics of, for instance, the optical devices forming the transponder 5. On the other hand, the environmental characteristics include the characteristics of the optical network NW (hereinafter, referred to as “optical network characteristics”) and the state of the transponder 5 (hereinafter, also referred to as a “device state”). The optical network characteristics correspond to, for instance, characteristics of the optical network itself such as characteristics of the optical fiber forming the optical network NW, each transmission distance between the transponders 5, types and a quantity of amplifiers provided between the transponders 5, and the like. In addition, the device state refers to a channel usage state by a user, whether the optical fiber is installed in the open air or under the ground, and external conditions such as a season, temperature, and the like. Note that the optical network characteristics can be considered as static environmental characteristics, while device state can be considered as dynamic environmental characteristics.

As such, the factor which influences the data distribution measured by each transponder 5 (hereinafter also referred to as an “influence factor”) is not a single factor. Therefore, in the present example embodiment, the analysis model to be used in each analyzer 10 is optimized step by step for each influence factor. That is, the model update unit 122 optimizes the analysis model by performing a model update for adapting the analysis model one by one to the unique characteristics, the optical network characteristics, and the device state. In this case, the number of optimization phases may be determined according to the number of influence factors; however, there is no restriction on the number of optimization phases. There is also no restriction on an order in which the model is adapted to each influence factor.

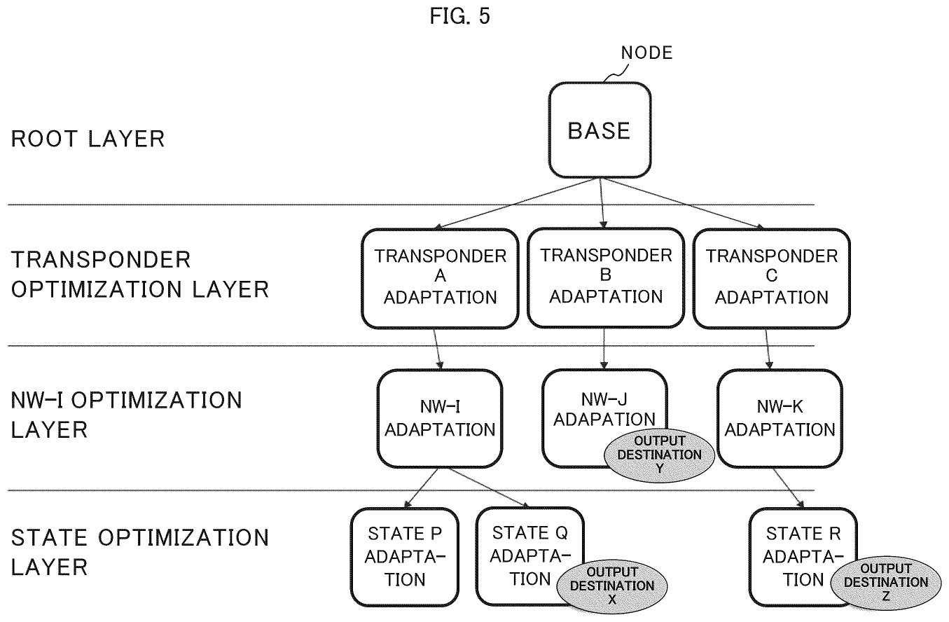

FIG. 5 schematically illustrates an example for the optimization phases of the analysis model. In the example in FIG. 5, the plurality of optimization phases are created in a tree structure, and include four layers indicating respective optimization phases. Rectangles depicted in each layer represent nodes in the tree structure, and correspond to respective processes for adapting the analysis model to the influence factors in the optimization phases and the adapted models. In the example in FIG. 5, the model update unit 122 optimizes the analysis model by adapting the analysis model in an order of the unique characteristics, the network characteristics, and the device state.

Specifically, in the example in FIG. 5, a first layer of the optimization phase corresponds to a root layer, a second layer corresponds to a transponder optimization layer, the third layer corresponds to a network (NW) optimization layer, and a fourth layer corresponds to a state optimization layer. Here, the route layer corresponds to a phase which creates a base model of the analysis model. The transponder optimization layer corresponds to a phase for adapting the analysis model to the unique characteristics of the transponder. The NW optimization layer corresponds to a phase for adapting the analysis model to the optical network characteristics. The state optimization layer corresponds to a phase for adapting the analysis model to the device state. In the present example embodiment, the model update unit 122 gradually adapts the analysis model to each influence factor according to the optimization phase illustrated in FIG. 5.

Note that FIG. 5 illustrates an example of the optimization phase, and as described above, the order in which the analysis model is adapted to each influence factor in the optimization is arbitrary. Therefore, the analysis model in a different order from the example in FIG. 5 may be adapted to the unique characteristics, the optical network characteristics, and the device state. Moreover, in FIG. 5, since the order of the layers for the optimization phase is fixed, the optimization phase is expressed by a tree structure, in a case where there is no order of the layers of the optimization phase, the optimization phase may be expressed by another data structure such as a graph structure, for instance.

### (Model Update Method)

Next, an update method of the analysis model will be described in detail.

### (1) When Installing New Model

Now, it is assumed now that a transponder A is installed in an environment of a customer X, and that the analysis model is output to an output destination X corresponding to the transponder A. In this case, the output destination X is the analyzer 10 corresponding to the transponder A.

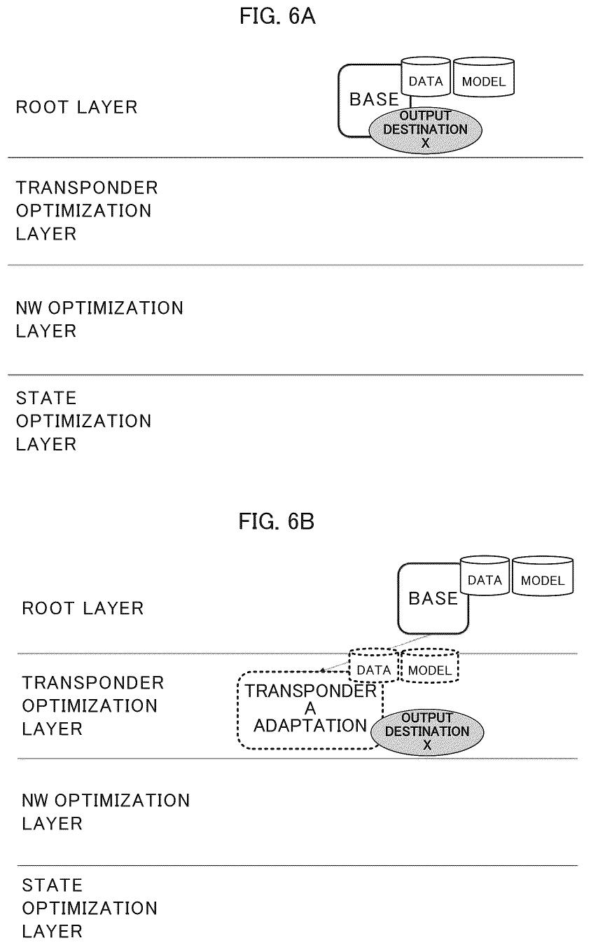

First, as depicted in FIG. 6A, in the route layer, the model update unit 122 collects data using a base transponder and a base network which are prepared in advance and generates the base model. The base transponder is a transponder with standard characteristics, and is different from the transponder A to be installed. The base network is a network with standard characteristics. Note that the base transponder and the base network can be provided in any manner. For instance, a transponder or network used other than the customer X may be used. In addition, the optimization phase management unit 125 creates a base node in the route layer, and sets the optimization phase of the customer X to be installed as the base node. The optimization phase management unit 125 stores the set optimization phase in the optimization phase storage unit 126.

Next, as depicted in FIG. 6B, in the transponder optimization layer, the model update unit 122 adapts the base model to the unique characteristics of the transponder A. Specifically, the model update unit 122 samples data using the transponder A and the base network, and updates the analysis model by performing additional training of the base model using the sampled data. The analysis model obtained by the update is called “transponder A adaptation model”. The optimization phase management unit 125 creates a “transponder A adaptation node” in the transponder optimization layer, shifts the optimization phase of the customer X to the transponder A adaptation node, and stores the optimization phase after the shift in the optimization phase storage unit 126.

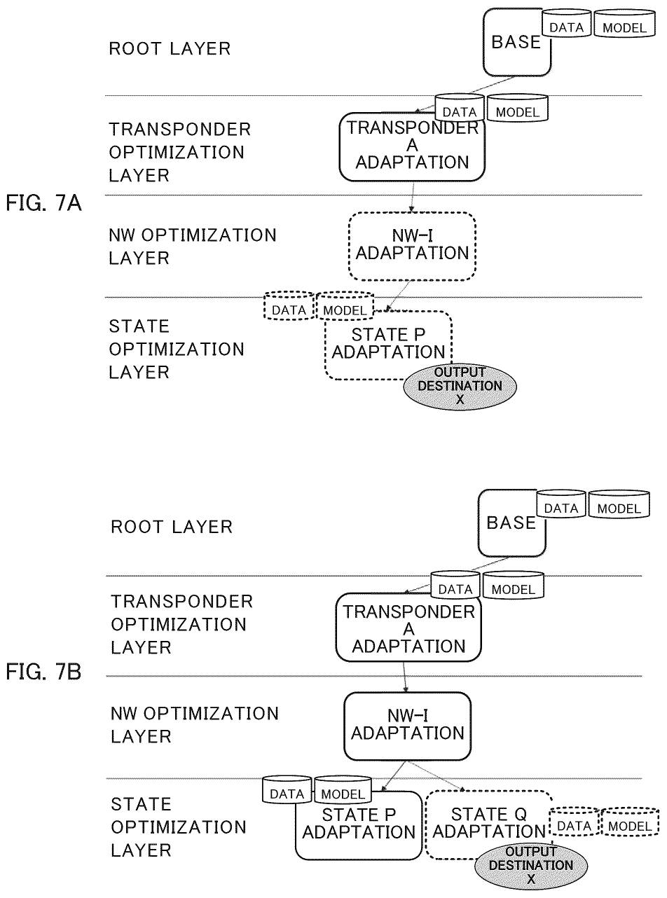

Next, as depicted in FIG. 7A, in the NW optimization layer and the state optimization layer, the model update unit 122 adapts the transponder A adaptation model to the customer X optical network characteristics and the device state. Specifically, the model update unit 122 samples data using the network NW-1 of the transponder A and the customer X in a state P of the customer X, and updates the analysis model by performing the additional training of the transponder A adaptation model using the collected data. The analysis model obtained by the renewal is called a “state P adaptation model”. The optimization phase management unit 125 creates an “NW-I adaptation node” and a “state P adaptation node” in additional NW optimization layer and the state optimization layer, shifts the optimization phase of the customer X to these nodes, and stores the optimization phase after the shift in the optimization phase storage unit 126.

Accordingly, the updated model, which has been adapted to the transponder A of the customer X, the network NW-I and the state P is acquired. The model output unit 124 transmits the acquired state P adaptation model to the output destination X, that is, the analyzer 10 corresponding to the transponder A of the customer X. After that, when the transponder A is in operation, the analyzer 10 analyzes the data measured by the transponder A using the output state P adaptation model.

As such, in the present example embodiment, the model update unit 122 updates the analysis model to gradually adapt the analysis model to each influence factor which affects the data distribution of the transponder. Therefore, even in a case where there is a large divergence between the data acquired in the environment where the base model is generated and the data acquired in the environment of the customer X, the model update is performed so as to reduce the discrepancy step by step, thus enabling the optimization of the analysis model used at a site of installation.

### (2) Response to Change in Device State

Now, assume that the device state changes while the state P adaptation model is in operation for the customer X. For instance, assume that there has been an environmental change such as a climate change. In this case, the model update unit 122 performs the model update in the state optimization layer. Now, suppose that the device state of the transponder A of the customer X has changed from the state P to a state Q. In this case, as illustrated in FIG. 7B, the model update unit 122 adapts the state P adaptation model to the state Q. Specifically, the model update unit 122 re-samples data using the transponder A and the network NW-I of the customer in the new state Q, and updates the analysis model by performing the additional training of the state P adaptation model using the sampled data. The analysis model acquired by the update is called a “state Q adaptation model”. Moreover, the optimization phase management unit 125 creates a “state Q adaptation node” in the state optimization layer, shifts the optimization phase of the customer X to the state Q adaptation node, and stores the optimization phase after the shift in the optimization phase storage unit 126.

Thus, when the device state changes, the analysis model adapted to the new state can be acquired by performing the model update in the state optimization layer. In the above example, the model update is performed during the environmental change such as the climate change or the like; however, a trigger for the model update in the state optimization layer is not limited to such the change. For instance, the model update unit 122 may perform the model update in the state optimization layer when the distribution of data acquired from the transponder A changes, or may perform the model update in the state optimization layer periodically at predetermined time intervals.

### (3) Creation of Generic Model

Next, a creation of a generic model (hereinafter, referred to as a “generic model”) for a plurality of data distributions will be described. As noted above, in a case where the device state of the transponder changes, the analysis model at the state optimization layer is updated. However, the update tends to occur more frequently than a replacement of the transponder or a replacement or modification of the optical network, as the device state is also subject to changes depending on the climate, the season, and other factors. Therefore, the generic model is created using the plurality of analysis models acquired by the model update which adapts to different states or using the plurality of analysis models and a plurality of pieces of data which are acquired by the model update which adapts to different states, and the model update in the state optimization layer is performed based on the generic model.

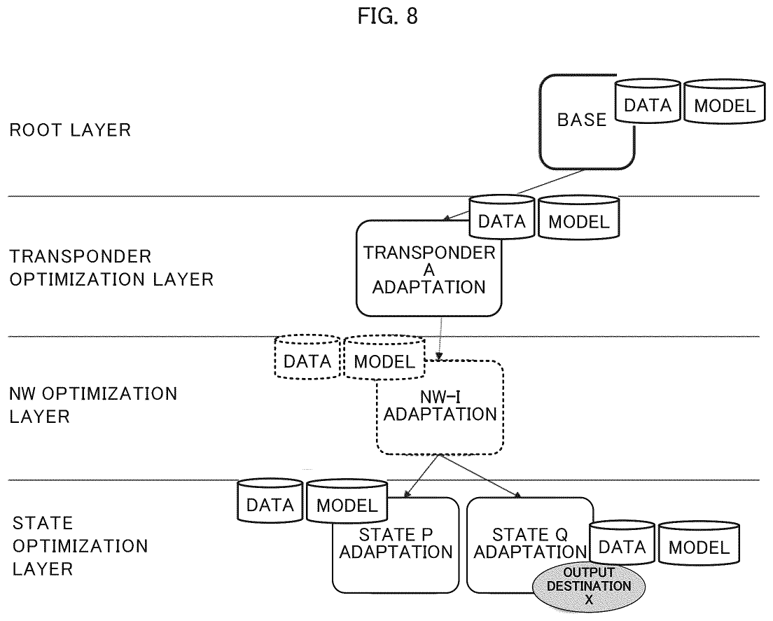

FIG. 8 is a diagram illustrating a method for creating a generic model. FIG. 8 illustrates a state where the transponder A is introduced to the customer X as described above, and the state P adaptation model and the state Q adaptation model are generated. Thus, in a state where two or more analytical models are generated in the state optimization layer for one transponder, the model update unit 122 generates an NW-I adaptation model corresponding to both the state P and the state Q, as a generic model. Specifically, the model update unit 122 samples pieces of data using the transponder A and an optical network NW-I of the customer X in the state P and the state Q. and generates the NW-I adaptation model by performing additional training to the transponder A adaptation model using these pieces of data. The NW-I adaptation model obtained by this additional training becomes a model in which features common to the state P and the state Q are learned, and becomes a generic model based on the state P adaptation model and the state Q adaptation model. The model update unit 122 stores a NW-I model as the generic model in the model storage unit 123.

Next, when the device state of the transponder A changes and the model update in the state optimization layer is necessary, the model update unit 122 performs the model update using the above-described generic model. For instance, in a case where the device state of the transponder A of the customer X changes to a new state G, the model update unit 122 performs the additional training of the NW-I adaptation model, which is the generic model, using the data sampled in the state G. and generates a state G adaptation model which is adapted to the state G. Thus, by creating the generic model of a plurality of models, it is possible to accurately and efficiently perform a subsequent model.

In the above-described example embodiment, the model update unit 122 creates the generic model of the NW optimization layer based on the plurality of analysis models and data of the state optimization layer. Alternatively or additionally, the model update unit 122 may create the generic model of the transponder optimization layer based on the plurality of analysis models and data of the NW optimization layer, may create the generic model of the root layer based on the plurality of analysis models and data of the transponder optimization layer, and may use the created generic model as a base model.

### (Example of Model Optimization)

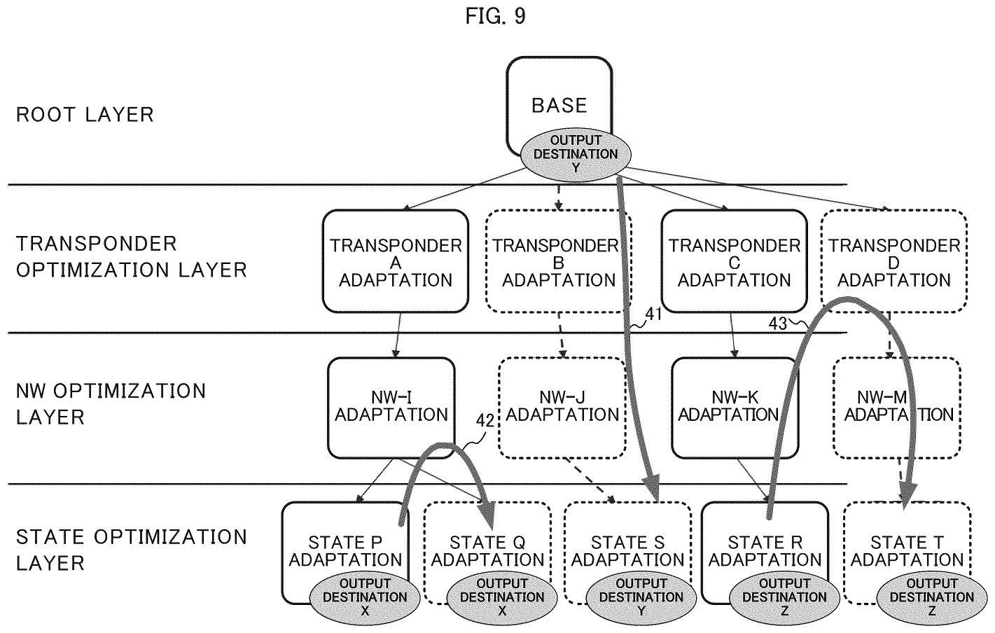

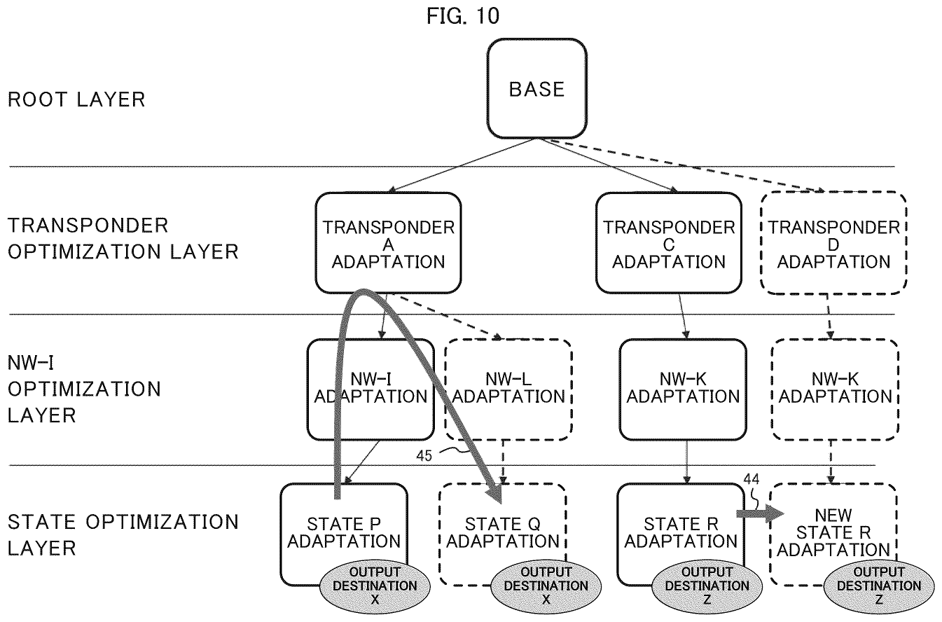

Next, referring to FIG. 9 and FIG. 10, examples of the optimization for the model in various cases will be described.

### (1) New Introduction

In FIG. 9, an arrow 41 indicates a flow of a process during an installation of a new transponder. This process is basically similar to the process described with reference to FIG. 6A, FIG. 6B, and FIG. 7. In a case of installing the transponder B to a new customer Y, the model update unit 122 first samples data using the base transponder and the base network to create the base model. Next, the model update unit 122 samples data using the transponder B and the base network, and performs the additional training of the base model using the data to generate the transponder B adaptation model. Next, the model update unit 122 samples data using a network NW-J of the transponder B and the customer Y in a state S of the customer Y, and performs the additional training of the transponder B adaptation model with the data to generate a state S adaptation model. Subsequently, the model output unit 124 outputs the state S adaptation model to an output destination Y (customer Y).

### (2) Response to State Change

In FIG. 9, an arrow 42 represents a flow of a process when the device state changes after the installation of the transponder. This process is basically similar to the process described with reference to FIG. 7B. As a premise, it is assumed that the transponder A has been installed for the customer X, and that the state P correspondence model corresponding to the state P of the customer X has been acquired. In this case, the model update unit 122 samples data using the network NW-I of the transponders A and the customers X in the state Q which has been changed, performs the additional training of the state P adaptation model by using the data, and generates the state Q adaptation model. Next, the model output unit 124 outputs the state Q adaptation model to the output destination X (customer X).

### (3) Replacement of Transponder and Optical Network

In FIG. 9, an arrow 43 represents a flow of a process when the transponder and the optical network are replaced. As a premise, it is assumed that a transponder C has been installed in a customer Z, and that a state R correspondence model corresponding to the state R of the customer Z has been obtained. The process in this case is basically similar to the case of the installation, and all model updates following the transponder are performed again. That is, the model update unit 122 first samples data using the base transponder and the base network, and creates the base model. Next, the model update unit 122 samples pieces of data using a transponder D and the base network after the replacement, and performs the additional training of the base model using the pieces of data to generate a transponder D adaptation model. Subsequently, the model update unit 122 samples data using a network NW-M of the transponder D and the customer Y in a state T of the customer Z, and performs the additional training of the transponder D adaptation model with the data to generate a state T adaptation model. After that, the model output unit 124 outputs the state T adaptation model to an output destination Z (customer Z).

### (4) Replacement of Transponder Only

In FIG. 10, an arrow 44 represents a flow of another process when only the transponder is replaced. In a case where only the transponder is replaced and there is no change in NW features or the device state, a state R adaptation model of the state optimization layer is adapted to the data of the transponder D. Specifically, in the state R, the model update unit 122 samples data using the new transponder D and an existing network NW-K, and performs the additional training of the state R adaptation model using the data to generate the new state R adaptation model corresponding to the transponder D. After that the model output unit 124 outputs the new state R adaptation model to the output destination Z (customer Z).

### (5) Network Replacement

In FIG. 10, an arrow 45 represents a flow of a process when the transponder remains the same but the network is replaced. The replacement of the network is, for instance, a replacement of an optical cable, a replacement of a device installed on the network such as the amplifier. When the network is replaced, the model update unit 122 performs the model update of the NW optimization layer and the state optimization layer. Specifically, the model update unit 122 samples data using the transponder A and a network NW-L in a state U. and performs the additional training of the transponder A adaptation model using the data to generate the state U adaptation model. Next, the model output unit 124 outputs the state U adaptation model to the output destination X (customer X).

### [Model Optimization Process]

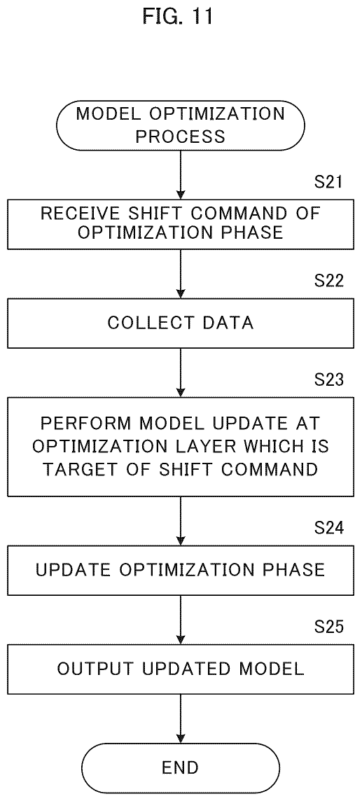

FIG. 11 is a flowchart of the model optimization process performed by the model update unit 122. This process is realized by the processor 112 illustrated in FIG. 2A, which executes a pre-prepared program and functions as each element depicted in FIG. 3.

First, the operator inputs a shift command of the optimization phase to the server 100 according to the installation or the replacement of the transponder or the network, and the optimization phase management unit 125 receives the shift command of the optimization phase which has been input (step S21). For instance, when the new transponder is installed, the shift command of the optimization phase is a command to perform the model update from the route layer to the state optimization layer, and when the network is replaced, the shift command is a command to perform the model update from the NW optimization layer to the state optimization layer.

Next, the model update unit 122 collects the data necessary for the model update (step S22). The data necessary for the model update may be collected in advance. Next, the model update unit 122 performs the model update in the optimization layer which is a target for the shift command (step S23), and updates the optimization phase stored in the optimization phase storage unit 126 (step S24). Then, the model update unit 122 outputs the model obtained by the update to the output destination (step S25). After that, the model optimization process is terminated.

### Modification

In the above embodiment, the analyzers 10 are basically installed at locations where corresponding transponders 5 is arranged, but instead, each 10 analyzers can be located together in the server 100. In this case, each analyzer 10 may perform the analysis using the data transmitted from the corresponding transponder 5.

In the above example embodiment, a model for estimating communication quality parameters based on the output data of the transponder installed in the optical network is optimized, but the application of the present disclosure is not limited thereto. The present disclosure can be applied to the optimization of the model for performing various predictions and estimations based on data acquired by a device installed in a certain environment.

### Second Example Embodiment

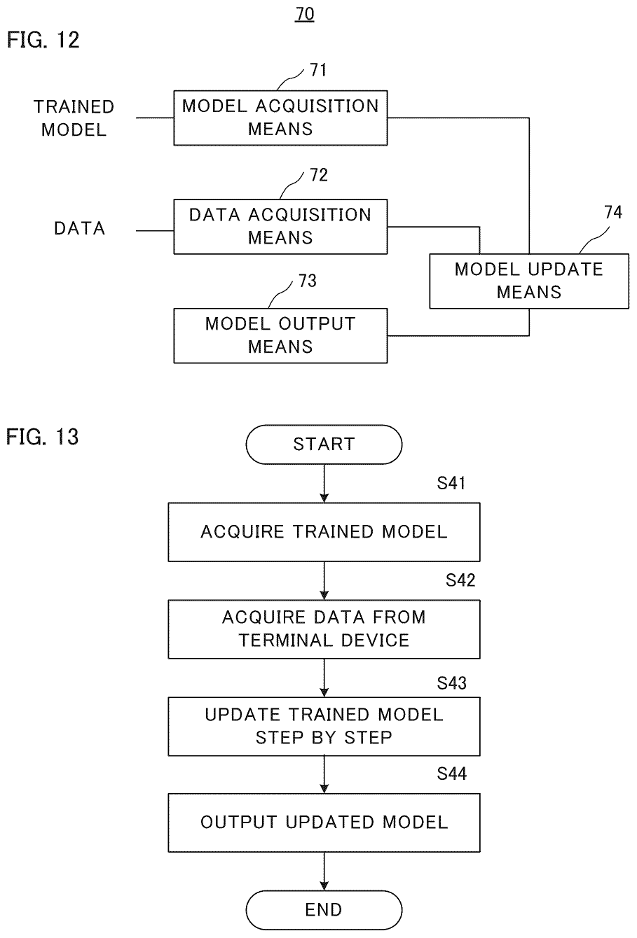

FIG. 12 is a block diagram illustrating a functional configuration of a model optimization device for a parameter estimation concerning optical communications according to a second example embodiment. The model optimization device 70 includes a model acquisition means 71, a data acquisition means 72, a model update means 73, and a model output means 74.

FIG. 13 is a flowchart of a process performed by the model optimization device 70 according to the second example embodiment. The model acquisition means 71 acquires the trained model (step S41). The data acquisition means 72 acquires data from the terminal device (step S42). The model update means 73 performs the model update of the trained model step by step based on the data, and generates the updated model (step S43). The model output means 74 outputs the updated model to an output destination device corresponding to the terminal device (step S44). After that, the process is terminated.

According to the model optimization device of the second example embodiment, it is possible to optimize the model to be used according to the unique characteristics and the environmental characteristics of the individual terminal devices.

A part or all of the example embodiments described above may also be described as the following supplementary notes, but not limited thereto.

### (Supplementary Note 1)

A model optimization device for a parameter estimation concerning optical communications, the model optimization device comprising:

a model acquisition means configured to acquire a trained model:

a data acquisition means configured to acquire data from a terminal device:

a model update means configured to generate an updated model by performing a model update of the trained model step by step based on the data; and

a model output means configured to output to an output destination device corresponding to the terminal device.

### (Supplementary Note 2)

The model optimization device according to supplementary note 1, wherein the model update means generates the updated model by performing, step by step, the model update which adapts the trained model to a different terminal device and the model update which adapts the trained model to a different environment.

### (Supplementary Note 3)

The model optimization device according to supplementary note 2, wherein the model update means performs the model update which adapts to the different environment after the model update which adapts to the different terminal device.

### (Supplementary Note 4)

The model optimization device according to supplementary note 1, wherein the model update means generates the updated model by performing, step by step, the model update which adapts to a different terminal device, the model update which adapts the trained model to a different network, and the model update which adapts the trained model to different states.

### (Supplementary Note 5)

The model optimization device according to any one of supplementary notes 1 to 4, wherein the model update means updates a model so as to adapt an analysis model to unique characteristics of the terminal device, optical network characteristics, an installation state of the terminal device step by step.

### (Supplementary Note 6)

The model optimization device according to supplementary note 4, wherein the model update means first performs the model update which adapts to the different terminal device, next performs the model update which adapts to the different network, and further performs the model update which adapts to the different states.

### (Supplementary Note 7)

The model optimization device according to supplementary note 4, wherein the model update means generates a generic model based on a plurality of updated models acquired by the model update which adapts to the different states.

### (Supplementary Note 8)

The model optimization device according to supplementary note 4, wherein the model update means generates a generic model based on a plurality of updated models and a plurality of pieces of data which are acquired by the model update which adapts to the different states.

### (Supplementary Note 9)

The model optimization device according to supplementary note 4, wherein the model update means generates a generic model based on a plurality of updated models acquired by the model update which adapts to the different network.

### (Supplementary Note 10)

The model optimization device according to supplementary note 4, wherein the model update means generates a generic model based on a plurality of updated models acquired by the model update which adapts to the different terminal device.

### (Supplementary Note 11)

A model optimization method for a parameter estimation concerning optical communications, the model optimization method comprising:

acquiring a trained model:

acquiring data from a terminal device:

generating an updated model by performing a model update of the trained model step by step based on the data; and

outputting the updated model to an output destination device corresponding to the terminal device.

### (Supplementary Note 12)

A recording medium storing a model optimization program for a parameter estimation concerning optical communications, the model optimization program causing a computer to perform a process comprising:

acquiring a trained model;

acquiring data from a terminal device;

generating an updated model by performing a model update of the trained model step by step based on the data; and

outputting the updated model to an output destination device corresponding to the terminal device.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

1 Optical network system
5 Transponder
6 Optical cable
7 Amplifier
10 Analyzer
12, 112 Processor
16 Analysis unit
17, 121 Data storage unit
100 Server
122 Model update unit
123 Model storage unit
124 Model output unit
125 Optimization phase management unit
126 Optimization phase storage unit

What is claimed is:

1. A model optimization device for a parameter estimation concerning optical communications, the model optimization device comprising:
a memory storing instructions; and
one or more processors configured to execute the instructions to:
acquire a trained model;
acquire data from a terminal device;
generate an updated model by performing a model update of the trained model step by step based on the data; and
output the updated model to an output destination device corresponding to the terminal device.

2. The model optimization device according to claim 1, wherein the processor generates the updated model by performing, step by step, the model update which adapts the trained model to a different terminal device and the model update which adapts the trained model to a different environment.

3. The model optimization device according to claim 2, wherein the processor performs the model update which adapts to the different environment after the model update which adapts to the different terminal device.

4. The model optimization device according to claim 1, wherein the processor generates the updated model by performing, step by step, the model update which adapts to a different terminal device, the model update which adapts the trained model to a different network, and the model update which adapts the trained model to different states.

5. The model optimization device according to claim 1, wherein the processor updates a model so as to adapt an analysis model to unique characteristics of the terminal device, optical network characteristics, an installation state of the terminal device step by step.

6. The model optimization device according to claim 4, wherein the processor first performs the model update which adapts to the different terminal device, next performs the model update which adapts to the different network, and further performs the model update which adapts to the different states.

7. The model optimization device according to claim 4, wherein the processor generates a generic model based on a plurality of updated models acquired by the model update which adapts to the different states.

8. The model optimization device according to claim 4, wherein the processor generates a generic model based on a plurality of updated models and a plurality of pieces of data which are acquired by the model update which adapts to the different states.

9. The model optimization device according to claim 4, wherein the processor generates a generic model based on a plurality of updated models acquired by the model update which adapts to the different network.

10. The model optimization device according to claim 4, wherein processor generates a generic model based on a plurality of updated models acquired by the model update which adapts to the different terminal device.

11. A model optimization method for a parameter estimation concerning optical communications, the model optimization method comprising:
acquiring a trained model;
acquiring data from a terminal device;
generating an updated model by performing a model update of the trained model step by step based on the data; and
outputting the updated model to an output destination device corresponding to the terminal device.

12. A non-transitory computer readable recording medium storing a program, the program causing a computer to perform a process comprising:
acquiring a trained model;
acquiring data from a terminal device;
generating an updated model by performing a model update of the trained model step by step based on the data; and
outputting the updated model to an output destination device corresponding to the terminal device.
